(19) United States
(12) Patent Application Publication
(10) Pub. No.: US 2012/0242207 A1
(43) Pub. Date: Sep. 27, 2012

(54) CONNECTION POINT FOR COMMUNICATION DEVICE ON APPLIANCE

(76) Inventors: Martin Mershon, Louisville, KY (US); John Gardner, Louisville, KY (US); Khalid Mashal, Louisville, KY (US); Joshua Mayne, Louisville, KY (US)

(21) Appl. No.: 13/053,265

(22) Filed: Mar. 22, 2011

(51) Int. Cl. F25D 23/02; H01R 13/40; H01R 43/00; E05D 11/00

(52) U.S. Cl. 312/237; 16/223; 248/200; 29/825; 439/527

(57) ABSTRACT

A connection point apparatus comprising an appliance door hinge cover; and an electrical connector mounted in an opening formed in the appliance door hinge cover and configured to accept an electrical connector connected to a communication device used to communicate with the appliance. Another connection point apparatus comprising an appliance machine compartment bracket; and an electrical connector mounted in an opening formed in the appliance machine compartment bracket and configured to accept an electrical connector connected to a communication device used to communicate with the appliance.

### BACKGROUND OF THE INVENTION

The subject matter disclosed herein relates to appliances, and more particularly to mounting a connection point for a communication device on such an appliance.

One example of a communication device that may require connection to an appliance is a device known as a demand side management (DSM) module. As is known, demand side management is a form of energy demand management that involves an electric utility company remotely controlling the quantity or patterns of use of energy consumed by end users with respect to their appliances. For example, a refrigerator appliance may be fitted with a DSM module that wirelessly receives transmitted commands from the electric utility company that serve to control the energy use of the refrigerator during periods when the energy supply network is constrained. That is, in response to received commands, the DSM module may cause a reduction in the energy use of the refrigerator by increasing the thermostat setting in the freezer compartment and/or the fresh food compartment during peak demand time periods tracked by the electric utility company.

The DSM module would be mounted to, or near, the refrigerator and would require an electrical connection point so that the DSM module could control the operation of the refrigerator based on the received commands from the electric utility company. However, selection of a connection point for the DSM module could require a complete redesign of the electrical harness of the appliance, and significantly impact the manufacturing assembly process as well. Also, selection of such a connection point could require significant redesign of one or more structural components of the refrigerator itself in order to provide mounting holes or supports. Finally, selection of such a connection point could negatively affect the appearance of the appliance.

Thus, it would be desirable to select and implement appliance connection points for communication devices, such as DSM modules, in a manner that addresses the above concerns.

### BRIEF DESCRIPTION OF THE INVENTION

As described herein, the exemplary embodiments of the present invention overcome one or more disadvantages known in the art.

One aspect of the present invention relates to a connection point apparatus comprising an appliance door hinge cover; and an electrical connector mounted in an opening formed in the appliance door hinge cover and configured to accept an electrical connector connected to a communication device used to communicate with the appliance.

Another aspect of the present invention relates to a connection point apparatus comprising an appliance machine compartment bracket; and an electrical connector mounted in an opening formed in the appliance machine compartment bracket and configured to accept an electrical connector connected to a communication device used to communicate with the appliance.

In one embodiment, the communication device is a DSM module and the appliance is a refrigerator.

Advantageously, illustrative apparatus and methods of the present invention provide for connection points to an appliance for a communication device that provide easy and unobtrusive access, and require little to no redesign of the electronics or electrical harnesses of the appliance.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 is a diagram illustrating a refrigerator appliance, in accordance with an embodiment of the invention.

FIG. 2 is a diagram illustrating a connection point for a communication device and a refrigerator appliance, in accordance with a first embodiment of the invention.

FIGS. 3-6 are diagrams illustrating views of components for implementing the connection point of FIG. 2.

FIG. 7 is a diagram illustrating a connection point for a communication device and a refrigerator appliance, in accordance with a second embodiment of the invention.

FIGS. 8-10 are diagrams illustrating views of components for implementing the connection point of FIG. 7.

### DETAILED DESCRIPTION OF THE EXEMPLARY EMBODIMENTS OF THE INVENTION

One or more of the embodiments of the invention will be described below in the context of a refrigerator appliance such as a household refrigerator. However, it is to be understood that methods and apparatus of the invention are not intended to be limited to use in refrigerators. Rather, methods and apparatus of the invention may be applied to and deployed in any other suitable appliance environments in which it would be desirable to mount and connect a communication device.

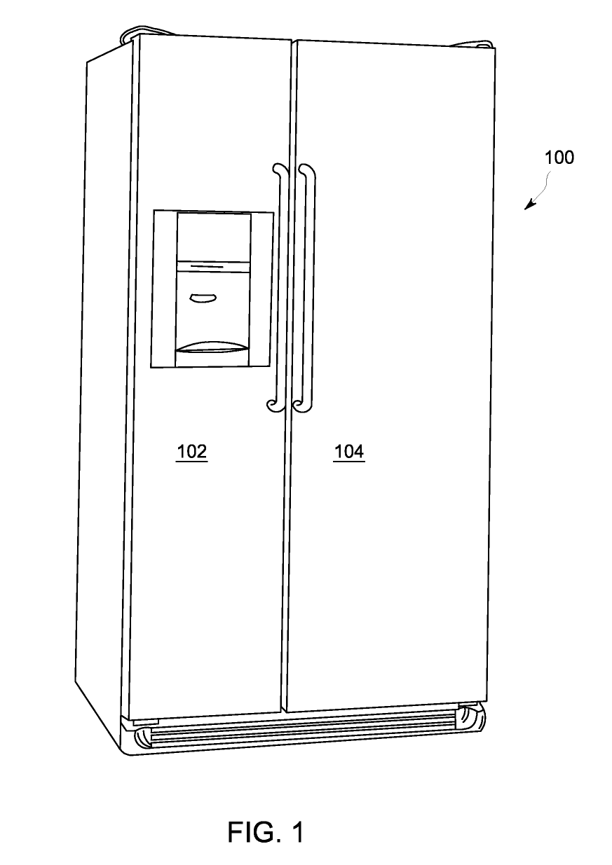

FIG. 1 illustrates an exemplary refrigerator appliance 100 in accordance with which one or more embodiments of the invention may be implemented. As is typical, a refrigerator has a freezer portion 102 and a refrigerator portion 104. The refrigerator portion typically maintains foods and products stored therein at temperatures at or below about 40 degrees Fahrenheit in order to preserve the items therein, and the freezer portion typically maintains foods and products at temperatures at or below about 32 degrees Fahrenheit in no order to freeze the items therein. The refrigerator portion 104 may also be referred to as a fresh food compartment, while the freezer portion 102 may be referred to as a freezer compartment.

While the exemplary refrigerator 100 in FIG. 1 illustrates the freezer portion 102 and the refrigerator portion 104 in a side-by-side configuration, it is to be understood that other configurations are known, such as top freezer configurations where the freezer portion 102 is situated on top of the refrigerator portion 104, and bottom freezer configurations where the freezer portion 102 is situated below the refrigerator portion 104. Also, viewing the refrigerator 100 from the front, the freezer portion 102 may be located to the right of the refrigerator portion 104, as opposed to being located to the left as shown in FIG. 1.

As mentioned above, integration of a communication device, such as a DSM module, with an appliance, such as a refrigerator, requires consideration of both functional and aesthetic concerns. Also, it is realized that integration of the communication device may be accomplished in a new appliance during the manufacturing and assembly process. However, in an existing appliance that is already deployed at a consumer location, e.g., the home of the person who already purchased the refrigerator, the integration of the communication device must be done in a retrofit manner on the customer premises. That is, a technician would have to go to the customer's home with a kit that, at least, includes the DSM module and electrical connectors necessary to electrically connect the DSM module to the control circuitry of the appliance.

Advantageously, methods and apparatus of the invention take into account these and other concerns in selecting and implementing appliance connection points for a communication device such as the DSM module. As will be evident from the detailed descriptions herein, the connection points chosen provide easy and unobtrusive access, and require little to no redesign of the refrigeration electronics or electrical harnesses of the appliance.

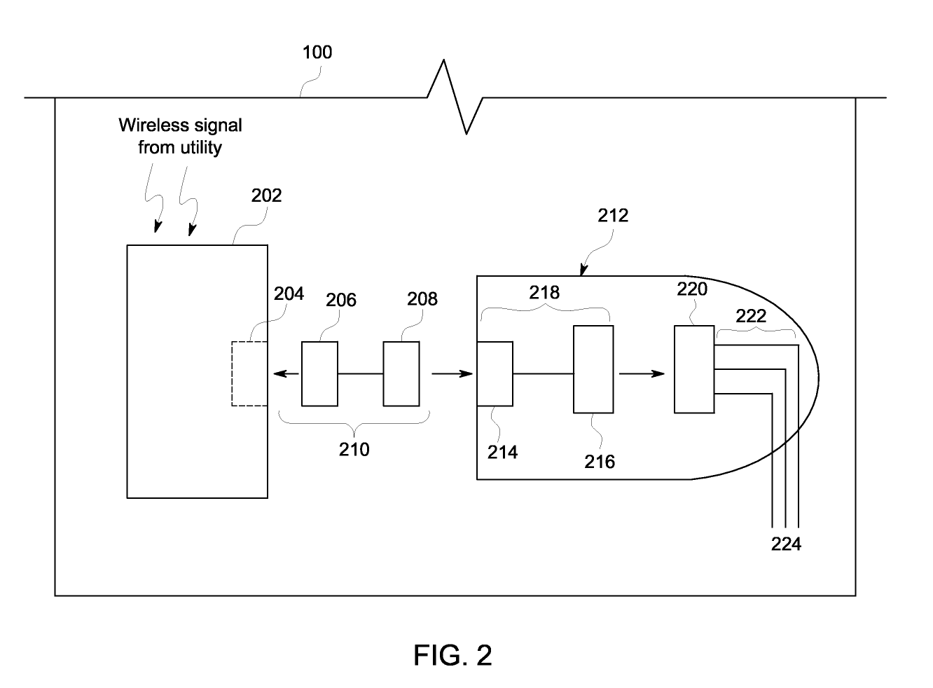

FIG. 2 illustrates a connection point for a communication device and a refrigerator appliance, in accordance with a first embodiment of the invention. In the embodiment of FIG. 2, the connection point for a DSM module is the hinge cover on the top of the freezer door of a refrigerator. Thus, in the case of the side-by-side refrigerator 100 in FIG. 1, the hinge cover can be seen at the top left side of the door of the freezer portion 102. Advantageously, by modifying the hinge cover, a mounting cutout is added that allows an electrical connector to be mounted therein. The hinge cover can then be installed in the typical fashion, on top of the hinge that holds the freezer door to the body of the refrigerator, giving external access for a DSM module to be connected to the refrigeration control circuitry. It is to be understood that the hinge cover on top of the fresh food compartment 104 could alternatively be used for the connection point, rather than the freezer portion hinge cover.

Thus, as shown in FIG. 2, a DSM module 202 is externally seated on top of refrigerator 100. An electrical connector 204 (e.g., female RJ45 Ethernet connector) is part of the DSM module 202. As shown, electrical connector 204 connects (as illustrated by the arrow) with Ethernet cable 210, which itself includes an electrical connector 206 male RJ45 Ethernet connector), connecting to electrical connector 204, and an electrical connector 208 (e.g., male RJ45 Ethernet connector) on the other end of the Ethernet cable 210.

Electrical connector 208 connects (as illustrated by the arrow) with an electrical connector 214 (e.g., female RJ45 Ethernet connector). Electrical connector 214 is part of an electrical cable 218 which has an electrical connector 216 (e.g., a 3-pin male connector) at the other end of the electrical cable 218. Electrical connector 216 connects (as illustrated by the arrows) with electrical connector 220 (e.g., 3-pin female connector). Electrical connector 220 is part of an electrical harness 222 that is part of the typical wiring harness that runs to/from the control circuitry 224 of the refrigerator 100. Note that electrical connector 214 is mounted in a cutout in hinge cover 212, and that the electrical cable 218, electrical connector 220, and at least part of the electrical harness 222 are housed under the hinge cover 212 when it is placed back over the hinge holding the freezer door to the body of the refrigerator.

It is to be understood that the control circuitry referred to herein may be one or more control boards with appropriate electronics for controlling the functions and operations of the refrigerator. One of ordinary skill in the art will fully understand the functions and operations of the refrigerator that are controlled by such control circuitry. Since the focus of principles of the invention is for providing methods and apparatus for permitting an unobtrusive and convenient electrical connection between a communication device and the control circuitry of the refrigerator, the present description does not go into detail about what type of control signals and control circuitry are employed. In this specific example illustrated herein, the communication device is a DSM module that operates in accordance with a Zigbee protocol and for which Ethernet (RJ45) connectors are employed to provide interconnection between the DSM module and the refrigerator. For example, the DSM module may be a General Electric (Fairfield, Conn.) part number DRM1E200R0WW. As is known, the Zigbee protocol is a high level communication protocol based on the IEEE 802.15.4-2003 standard. One of ordinary skill in the art will appreciate what types of signals and information need to be transmitted to permit the DSM module to control the functions and operations of the refrigerator based on commands (e.g., wireless signals) the DSM module receives from an electrical utility. Accordingly, a discussion of these signals and wireless protocols is considered to be beyond the scope of the invention. Note also that principles of the invention are not intended to be limited to any particular communication device or communication signal protocol, thus, the Zigbee and Ethernet protocols are mentioned merely as examples. Furthermore, the General Electric DSM module mentioned above is also merely intended to be an example, i.e., other DSM modules or communication devices could be used in accordance with the invention.

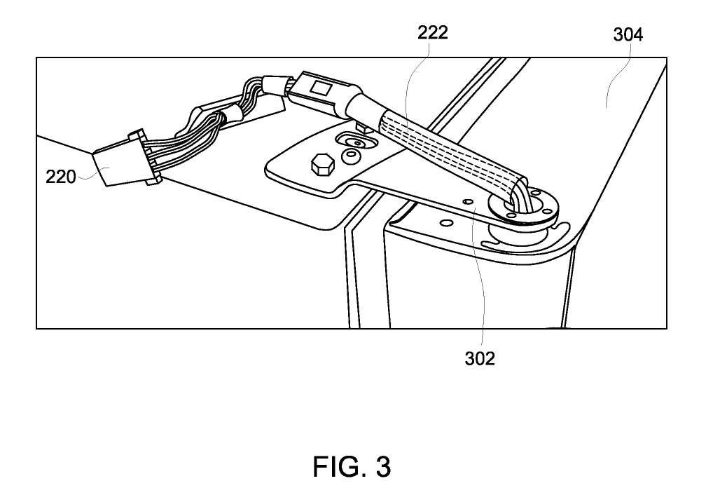

FIGS. 3-6 are diagrams illustrating views of components for implementing the connection point of FIG. 2.

More particularly, FIG. 3 shows a view of the hinge 302, with hinge cover 212 removed, at the top of the freezer door 304 of refrigerator 100. Electrical connector 220 and part of electrical harness 222 are shown. Note that the harness 222 runs into the freezer door and is routed back to the control circuitry of the refrigerator. It is to be understood that such connector 220 and harness 222 are typically provided on a refrigerator appliance as a test point for manufacturing testing of the appliance. The connector and harness are then hidden under the hinge cover 212 when released from production.

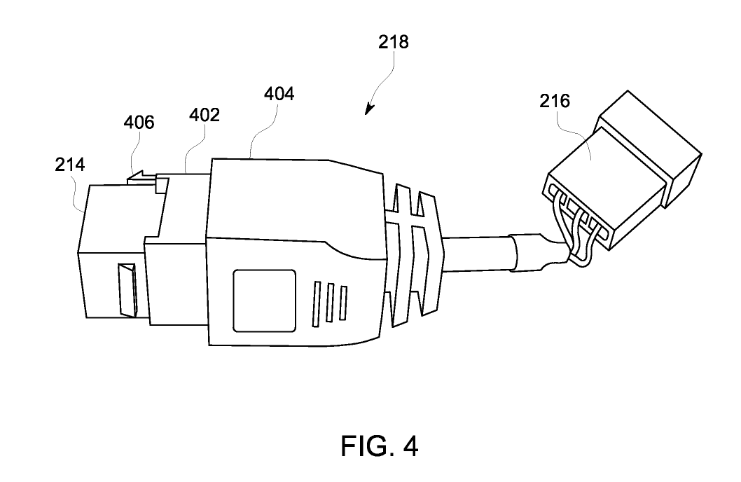

FIG. 4 shows electrical cable 218, with electrical connectors 214 and 216, in a disconnected state. As mentioned above, cable 218 is the cable that remains under the hinge cover 1 and whose connector 214 is mounted in a cutout in the hinge cover. Note that, as shown, the shape of the connector 214 includes a narrow portion 402 and a wide portion 404. The narrow portion 402 has a flexible tab feature 406. The narrow portion 402 of connector 214 goes through the opening of the cutout in the hinge cover up to the point where the wide portion 404 contacts the inside wall of the hinge cover. The flexible tab 406, which squeezes through the opening in the cutout, then spreads holding the connector 214 in place in the cutout. To release the connector 214 from the cutout, the flexible tab 406 is depressed, and the narrow portion 402 is pushed or pulled back through the opening in the cutout.

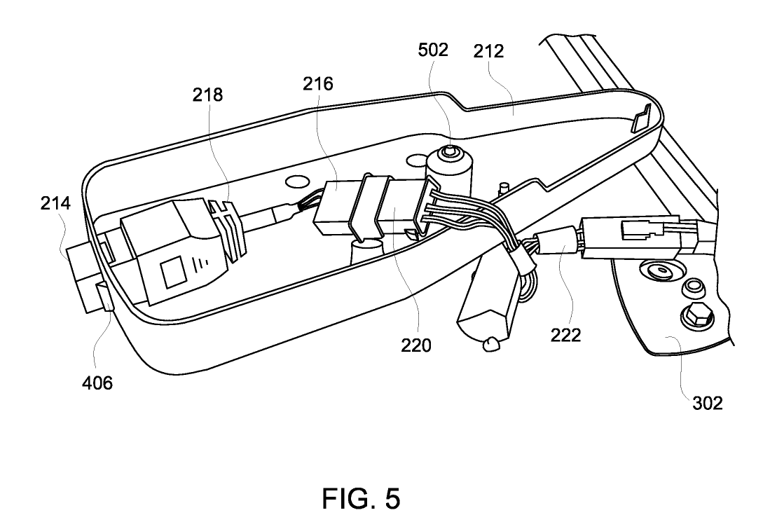

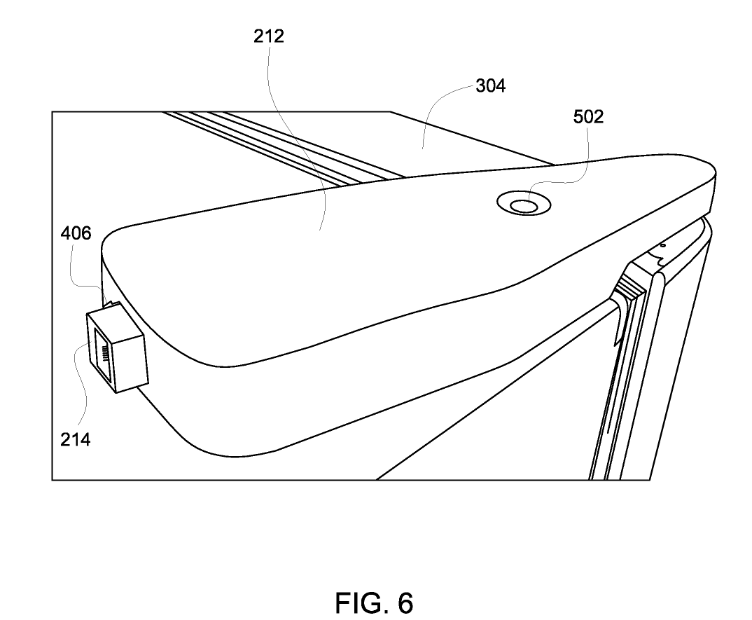

FIG. 5 shows the electrical cable 218 connected to the electrical harness 222, and the electrical connector 214 inserted and held in the opening of the cutout of the hinge cover 212. FIG. 6 illustrates the hinge cover 212, with the cable 218 and the harness 222 underneath, flipped over and reattached to the hinge 302 via screw 502. Note that the protruding connector 214 is oriented toward the back of the refrigerator (opposite the direction of the freezer door) so that it is not easily visible to anyone standing in front of the refrigerator. Also, the fact that the connection point in this embodiment is on top of the refrigerator 100 advantageously provides for the ability to mount the DSM module 202 and its connection point in an out of the way location on the refrigerator.

Then, to complete the electrical interconnection of the DSM module 202 to the control circuitry 224 of the refrigerator 100, electrical connector 208 of the Ethernet cable 210 is connected to the narrow portion of the connector 214 protruding from the hinge cover 212, while the other end of cable 210, i.e., connector 206, is connected to connector 204 on the DSM module 202.

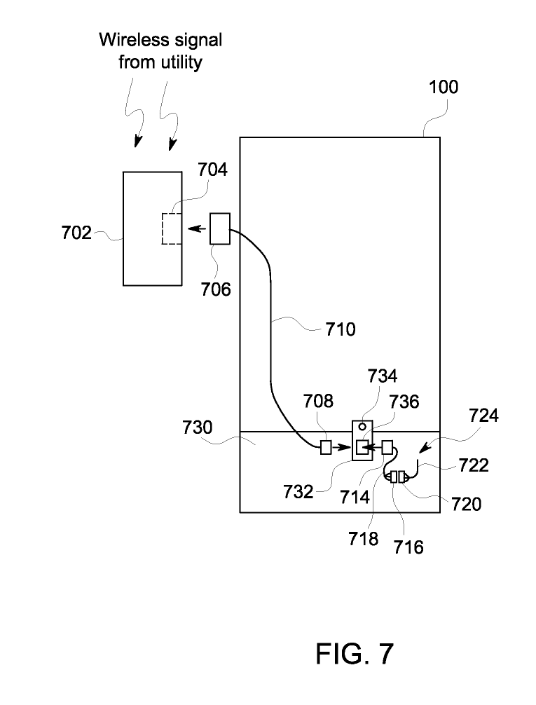

FIG. 7 illustrates a connection point for a communication device and a refrigerator appliance, in accordance with a second embodiment of the invention. In the embodiment of FIG. 7, the connection point for a DSM module is machine compartment of the refrigerator 100. As is known, the machine compartment is an area in the back of the refrigerator at the bottom by the floor. By installing a bracket for mounting an electrical connector to the body of the refrigerator near the machine compartment, the DSM module can be connected to the control circuitry in an unobtrusive location, i.e., behind the refrigerator.

As shown in FIG. 7, a bracket 732 is mounted to the refrigerator case down by the machine compartment 730. The bracket 732 is held to the case by a fastener 734 and has an opening 736 for accepting the mounting of an electrical connector. Note that the remaining components numbered in FIG. 7 that have the same function as like components in the embodiment of FIG. 2 are numbered similarly but incremented by 500.

Thus, as shown in FIG. 7, a DSM module 702 is externally mounted on refrigerator 100 (e.g., the module could be seated on top of the refrigerator as long as the connecting cable is long enough to reach the connection point by the machine compartment 730). An electrical connector 704 (e.g., female RJ45 Ethernet connector) is part of the DSM module 702. As shown, electrical connector 704 connects (as illustrated by the arrow) with Ethernet cable 710, which itself includes an electrical connector 706 (e.g., male RJ45 Ethernet connector), connecting to electrical connector 704, and an electrical connector 708 (e.g., male RJ45 Ethernet connector) on the other end of the Ethernet cable 710.

Electrical connector 708 connects (as illustrated by the arrow) with an electrical connector 714 (e.g., female RJ45 Ethernet connector). Electrical connector 714 is part of an electrical cable 718 which has an electrical connector 716 (e.g. a 3-pin male connector) at the other end of the electrical cable 718. Electrical connector 716 connects (as illustrated by the arrows) with electrical connector 720 (e.g., 3-pin female connector). Electrical connector 720 is part of an electrical harness 722 that is part of the typical wiring harness that runs to/from the control circuitry 724 of the refrigerator 100. Note that electrical connector 714 is mounted in the opening 736 of bracket 732 and accepts connector 708 of cable 710 so that the DSM module 702 is connected to the control circuitry (e.g., one or more control boards) so as to provide the DSM functionality described above.

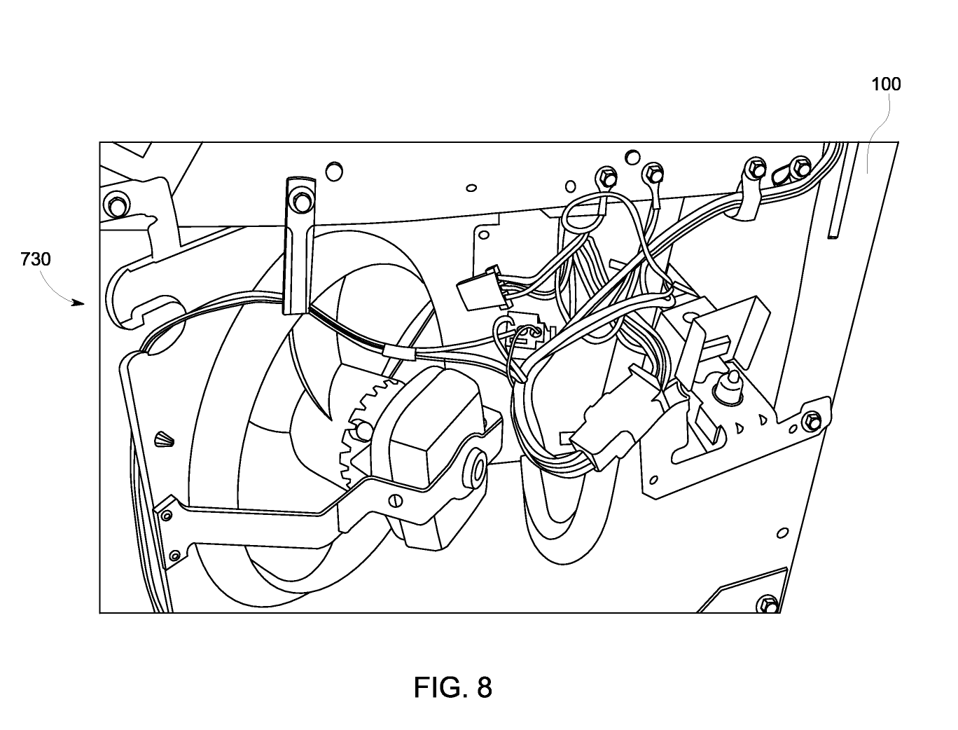

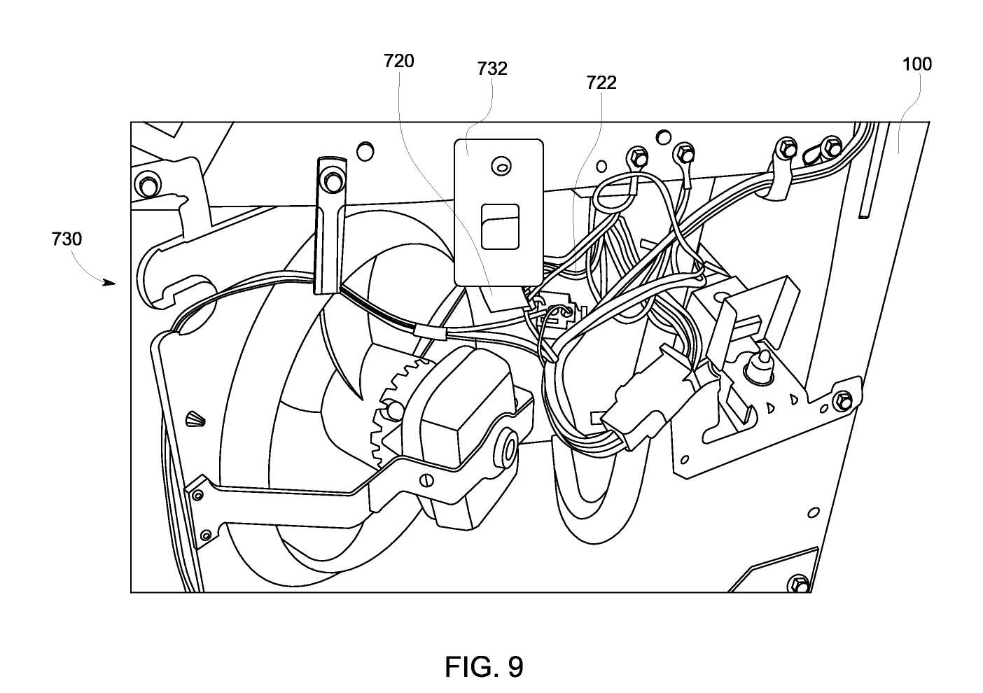

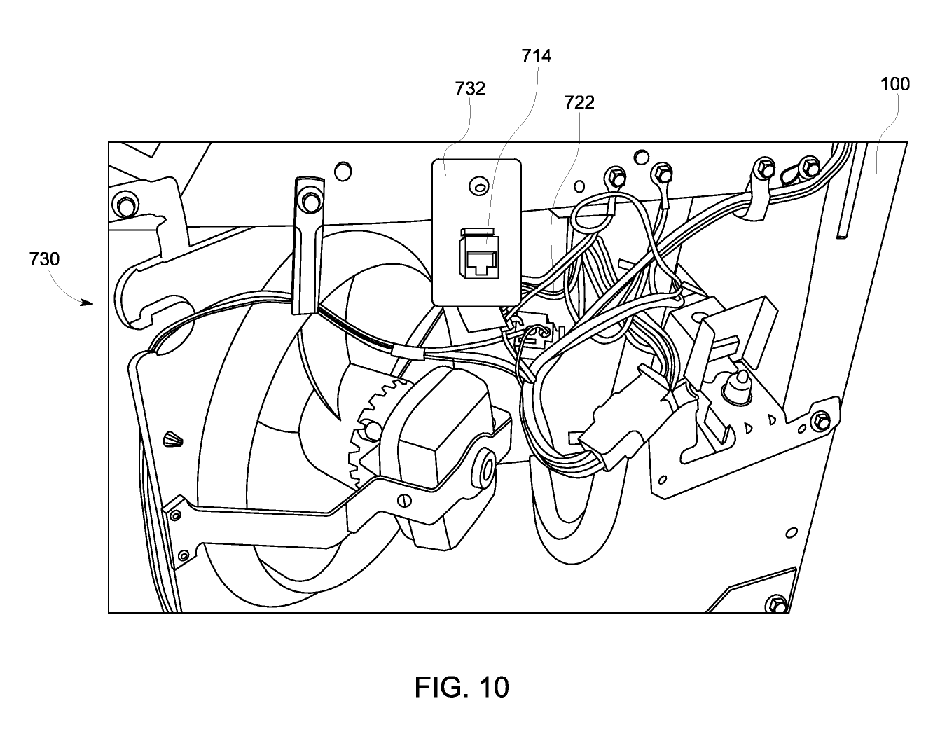

FIGS. 8-10 are diagrams illustrating views of components for implementing the connection point of FIG. 7. More particularly, FIG. 8 generally shows the machine compartment 730 at the back lower area of the refrigerator 100. FIG. 9 shows the bracket 732 mounted to the refrigerator case, and the connector 720 and harness 722 that goes to the control circuitry. FIG. 10 shows the electrical connector 714 installed in the opening 736 of the bracket 732. The connector 714 may be held in place by a flexible tab as in the embodiment of FIG. 2, or by some alternate retention mechanism.

Then, to complete the electrical interconnection of the DSM module 702 to the control circuitry of the refrigerator 100, electrical connector 708 of the Ethernet cable 710 is connected to the connector 714, while the other end of cable 710, i.e., connector 706, is connected to connector 704 on the DSM module 702.

Note also that, while the figures illustrate connectors as being either male or female, principles of the invention are not intended to be limited to any particular type of connector or mating convention thereof.

Note also that when the refrigerator is being manufactured with the connection points for the DSM module integrated therewith, all connectors, cables, cutouts and brackets can be manufactured and assembled before delivery to a customer's premises. However, when the refrigerator is being retrofitted because it has already been deployed at the customer premises, a technician would bring a parts kit that includes the components shown in FIG. 2 other than the hinge cover 212, connector 220 and harness 222. The hinge cover would be modified (i.e., the cutout would be formed therein by the technician). Alternately, a pre-modified hinge cover (with cutout already provided) could be part of the kit such that the technician would simply replace the existing (unmodified) hinge cover with the modified cover. Also, any control board changes that would be necessary to affect the DSM module functionality could be implemented at the time of the retrofit. Likewise, in the embodiment of FIG. 7, the components other than the connector 720 and harness 722 would be part of the retrofit kit.

Note also that, while the communication device is shown external to the appliance in the embodiments of FIGS. 2 and 7, it is to be understood that the communication device could be located (e.g., seated, mounted, etc.) internal to the appliance.

It is to be appreciated that the control circuitry described herein may include, but is not limited to, a microprocessor (processor) that is programmed, for example, with suitable software or firmware, to implement control functions and refrigeration operations described herein. In other embodiments, an ASIC (Application Specific Integrated Circuit) or other arrangement could be employed. One of ordinary skill in the art will be familiar with refrigeration systems and given the teachings herein will be enabled to make and use one or more embodiments of the invention; for example, by programming a microprocessor with suitable software or firmware to cause the refrigeration system to perform illustrative steps described herein. Software includes but is not limited to firmware, resident software, microcode, etc. As is known in the art, functions and operations discussed herein may be distributed as an article of manufacture that itself comprises a tangible computer readable recordable storage medium having computer readable code means embodied thereon. The computer readable program code means is operable, in conjunction with a computer system or microprocessor, to carry out all or some of the steps to perform the methods or create the apparatuses discussed herein. A microprocessor may include and/or be coupled to a suitable memory.

Furthermore, it is also to be appreciated control functions and refrigeration operations described herein may be implemented in electronic systems under control of one or more microprocessors and computer readable program code, as described above, or in electromechanical systems where functions and operations are under substantial control of mechanical control systems rather than electronic control systems.

Thus, while there have been shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An apparatus comprising:
an appliance door hinge cover; and
an electrical connector mounted in an opening formed in the appliance door hinge cover and configured to accept an electrical connector connected to a communication device used to communicate with the appliance.

2. The apparatus of claim 1, further comprising an electrical cable connected at one end to the electrical connector mounted in the opening formed in the appliance door hinge cover.

3. The apparatus of claim 2, wherein the electrical cable further comprises another electrical connector connected at another end of the electrical cable.

4. The apparatus of claim 3, wherein the other electrical connector of the electrical cable is connected to an electrical harness connected to control circuitry of the appliance.

5. The apparatus of claim 1, wherein the communication device is a demand side management module.

6. The apparatus of claim 1, wherein the appliance is a refrigerator.

7. An apparatus comprising:
an appliance machine compartment bracket; and
an electrical connector mounted in an opening formed in the appliance machine compartment bracket and configured to accept an electrical connector connected to a communication device used to communicate with the appliance.

8. The apparatus of claim 7, further comprising an electrical cable connected at one end to the electrical connector mounted in the opening formed in the appliance machine compartment bracket.

9. The apparatus of claim 8, wherein the electrical cable further comprises another electrical connector connected at another end of the electrical cable.

10. The apparatus of claim 9, wherein the other electrical connector of the electrical cable is connected to an electrical harness connected to control circuitry of the appliance.

11. The apparatus of claim 7, wherein the communication device is a demand side management module.

12. The apparatus of claim 7, wherein the appliance is a refrigerator.

13. A refrigerator appliance comprising:
a door hinge cover;
an electrical connector mounted in an opening formed in the door hinge cover and configured to accept an electrical connector connected to a communication device used to communicate with the refrigerator appliance;
an electrical cable connected at one end to the electrical connector mounted in the opening formed in the door hinge cover, wherein the electrical cable further comprises another connector connected at another end of the electrical cable; and
an electrical harness connected to control circuitry of the appliance, wherein the other electrical connector of the electrical cable is connected to the electrical harness connected to the control circuitry of the refrigerator appliance.

14. The refrigerator appliance of claim 13, wherein the communication device is a demand side management module.

15. A refrigerator appliance comprising:
a machine compartment bracket;
an electrical connector mounted in an opening formed in the machine compartment bracket and configured to accept an electrical connector connected to a communication device used to communicate with the refrigerator appliance;
an electrical cable connected at one end to the electrical connector mounted in the opening formed in the machine compartment bracket, wherein the electrical cable further comprises another connector connected at another end of the electrical cable; and
an electrical harness connected to control circuitry of the appliance, wherein the other electrical connector of the electrical cable is connected to the electrical harness connected to the control circuitry of the refrigerator appliance.

16. The refrigerator appliance of claim 15, wherein the communication device is a demand side management module.

17. A method comprising:
modifying an appliance door hinge cover to form an opening therein; and
mounting an electrical connector in the opening formed in the appliance door hinge cover wherein the mounted electrical connector is configured to accept an electrical connector connected to a communication device used to communicate with the appliance, and the mounted electrical connector is connected to an electrical harness connected to the control circuitry of the appliance.

18. A method comprising:
mounting a bracket having an opening therein in the proximity of an appliance machine compartment; and
mounting an electrical connector in the opening formed in the appliance machine compartment bracket wherein the mounted electrical connector is configured to accept an electrical connector connected to a communication device used to communicate with the appliance, and the mounted electrical connector is connected to an electrical harness connected to the control circuitry of the appliance.
